(19) United States
(12) Patent Application Publication
(10) Pub. No.: US 2025/0280748 A1
(43) Pub. Date: Sep. 11, 2025

(54) SHANK AND PACKING FORCES FOR FURROW OPENERS

(71) Applicant: SEEDMASTER MANUFACTURING LTD., Emerald Park (CA)

(72) Inventors: Chance PEUTERT, Emerald Park (CA); Thomas KARY, Emerald Park (CA); Matthew PETRUIC, Emerald Park (CA); Jeremy SEIDLITZ, Emerald Park (CA); Greg VENNARD, Emerald Park (CA); Norbert BEAUJOT, Emerald Park (CA)

(21) Appl. No.: 19/069,437

(22) Filed: Mar. 4, 2025

(30) Foreign Application Priority Data
Mar. 5, 2024 (CA) 3231138

(51) Int. Cl. A01B 61/04; A01B 63/32; A01C 5/06

(52) U.S. Cl. CPC A01B 61/048; A01B 63/32; A01C 5/062; A01C 5/064

(57) ABSTRACT

A seeding apparatus comprises an implement frame mounted on wheels and a trailing arm pivotally attached at a front portion thereof to the implement frame about a horizontal arm pivot axis and extending rearward and downward to a packer wheel rotatably attached. An arm bias element attached to the implement frame and to the trailing arm operates to exert a downward and forward arm bias force on the on the trailing arm. A shank is pivotally attached at an upper portion thereof to a middle portion of the trailing arm about a horizontal shank pivot axis, and a furrow opener is attached to a lower end of the shank. A shank bias element is connected between the trailing arm and the shank and operates to exert a forward and downward shank bias force on the shank to maintain the shank in a shank operating position.

### CROSS-REFERENCE TO RELATED APPLICATIONS

This application claims priority to CA 3231138 filed Mar. 5, 2024, the entire contents of which are hereby incorporated by reference.

This invention relates to agricultural implements and more specifically to a seeding apparatus for seeding agricultural fields.

### BACKGROUND

Air seeders typically have at least one product tank for carrying seed, and a fan operative to create an air stream to distribute the seed to furrow openers laterally spaced along a wheeled implement frame.

U.S. Pat. No. 10,681,858 to Beaujot shows such an implement frame with a trailing arm pivotally attached at a front end thereof to the frame about a horizontal arm pivot axis and extending downward and rearward to a packer wheel rotatably mounted on the rear end thereof. A hydraulic cylinder is attached between the frame and the trailing arm and exerts a downward bias force on the trailing arm about the arm pivot axis forcing the packer wheel against the ground and pushing a furrow opener, attached to a downward extending shank, into the ground at a depth dictated by the vertical distance between the furrow opener and the bottom of the packer wheel.

When an obstruction, such a large rock or the like, is encountered by the furrow opener the furrow opener “trips”, rotating the trailing arm such against the bias force such that the furrow opener moves upward and somewhat rearward over the obstruction and then moves downward and forward once the obstruction is passed.

U.S. Pat. No. 10,681,858 shows the furrow opener rigidly attached to the trailing arm in one version, and pivotally attached to the trailing arm about a substantially horizontal shank pivot axis in a second version. This pivotal attachment is common in the industry. The single bias element is connected to implement frame and to the shank either above or below the shank pivot axis and the bias force moves the furrow opener into the ground and the packer wheel against the ground. This arrangement allows the furrow opener to move against the bias force from the operating position rearward to clear the obstruction.

Similarly, U.S. Pat. No. 10,405,486 to Jagow illustrates a trailing arm assembly comprising upper and lower parallel arms, and U.S. Patent Application 2011/0282556 of Klenz et al. shows again a trailing arm assembly with upper and lower parallel arms, and also an actuator operative to move the packer wheel upward and downward with respect to the trailing arm to adjust the furrow depth.

Air seeders are also known which deliver seed and fertilizer to separate furrow openers mounted on the trailing arm. U.S. Pat. No. 5,396,851 to Beaujot illustrates such an arrangement, as does U.S. Pat. No. 6,986,313 to Halford et al.

### SUMMARY OF THE INVENTION

It is an object of the present invention to provide a seeding apparatus that overcomes problems in the prior art.

In a typical prior art trailing arm type seeding implement, a trailing arm is pivotally attached to the implement frame about an arm pivot axis and slopes downward and rearward to a packer wheel rotatably attached about a rotational axis to the rear end of the trailing arm. A shank extends downward from the trailing arm to the furrow opener.

An arm bias element, which is typically provided by a hydraulic cylinder but could also be provided by a spring or the like, exerts the required downward and forward force between the implement frame and the trailing arm to push the furrow opener into the soil and also to force the packer wheel against the ground behind the furrow opener. The arm bias element pushes the trailing arm downward and forward and the trailing arm moves upward and rearward and also downward and forward with respect to the implement frame as the implement moves along undulating soil surfaces, When the furrow opener encounters a rock or like obstruction, the trailing arm rotates about the arm pivot axis against the arm bias force and the furrow opener and the packer wheel both move upward and rearward until the furrow opener and the packer wheel clear the obstruction and the arm bias element pushes the furrow opener and packer wheel down into the operating position.

In other prior art implements, the trailing arm and shank are both pivotally attached to the implement and biased into the ground by separate bias elements.

The present invention provides a shank pivotally connected at an upper portion thereof to a middle portion of the trailing arm about a shank pivot axis and a furrow opener attached at the lower end of the shank. A shank bias element is connected at one end to the trailing arm and at the other end to the shank and exerts a forward and downward shank bias force on the shank and attached furrow opener.

When encountering an obstruction, the furrow opener and shank move rearward and upward against the shank bias force while the arm bias force maintains the packer wheel against the ground. The shank typically has a limited pivotal travel path before it bears against a stop, at which point the further rearward and upward movement raises the trailing arm and the packer wheel against the arm bias force.

In a first embodiment the present disclosure provides a seeding apparatus comprising an implement frame mounted on wheels for travel over the ground in an operating travel direction. A trailing arm is pivotally attached at a front portion thereof to the implement frame about a substantially horizontal arm pivot axis and extending rearward and downward to a packer wheel rotatably mounted to a rear portion of the trailing arm about a substantially horizontal packer rotational axis. An arm bias element is attached to the implement frame and to the trailing arm and operates to exert a downward and forward arm bias force on the on the trailing arm about the arm pivot axis. A shank is pivotally attached at an upper portion thereof to a middle portion of the trailing arm about a substantially horizontal shank pivot axis, and a furrow opener is attached to a lower end of the shank. A shank bias element is connected between the trailing arm and the shank and operates to exert a substantially forward and downward shank bias force on the shank to maintain the shank in a shank operating position.

In a second embodiment the present disclosure provides a seeding apparatus comprising an implement frame mounted on wheels for travel over the ground in an operating travel direction. A trailing arm is pivotally attached at a front portion thereof to the implement frame about a substantially horizontal arm pivot axis and extends rearward and downward to a packer wheel rotatably mounted to a rear portion of the trailing arm about a substantially horizontal packer rotational axis. A shank extends downward from a middle portion of the trailing arm, and a furrow opener is mounted on a lower end of the shank. A front end of the trailing arm extends forward of the arm pivot axis, and an arm bias element is attached to the implement frame and to the front end of the trailing arm and operates to exert an arm bias force on the front end of the trailing arm to exert a downward and forward arm bias force on the on the trailing arm.

The present disclosure thus provides a trailing arm type seeding implement with a shank that is pivotally attached to the trailing arm and a bias element acting to pivot the shank to an operating position and allowing the shank to move rearward and upward when an obstruction is encountered with reduced effect on the down pressure the trailing arm exerts on the packer wheel.

The present disclosure also provides a novel location for the arm bias element that is forward of the arm pivot axis such that an upward force on the front end of the trailing arm forces the packer wheel and shank downward.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of an embodiment of the present invention showing a shank pivotally attached to a trailing arm, and a retracting hydraulic cylinder pulling the shank into the shank operating position;

FIG. 2 is a schematic side view of an alternate embodiment of the present invention showing a shank pivotally attached to a trailing arm, and an extending hydraulic cylinder pushing the shank into the shank operating position;

FIG. 3 is a schematic side view of a further alternate embodiment of the present invention showing front and rear shanks pivotally attached to a trailing arm and connected by a tether, and a retracting hydraulic cylinder pulling the front and rear shanks into corresponding front and rear shank operating positions;

FIG. 4 is a schematic side view of the embodiment of FIG. 1 encountering an obstruction that is sufficiently large to raise the packer wheel above the ground;

FIG. 5 is a schematic side view of an alternate embodiment of the present invention where the front end of the trailing arm extends forward from the arm pivot axis and the arm bias element exerts an upward force on the front end of the trailing arm;

FIG. 6 is a perspective view of a further alternate embodiment of the present invention wherein the trailing arm comprises a parallel arm assembly;

FIG. 7 is a side view of the embodiment of FIG. 6;

FIG. 8 is a rear view of the embodiment of FIG. 6;

FIG. 9 is a top view of the embodiment of FIG. 6;

FIG. 10 is a sectional side view taken along section 10-10 in FIG. 8.

### DETAILED DESCRIPTION OF THE ILLUSTRATED EMBODIMENTS

FIG. 1 schematically illustrates a seeding apparatus 1 comprising an implement frame 3 mounted on wheels 5 for travel over the ground 7 in an operating travel direction T. A trailing arm 9 is pivotally attached at a front portion 9F thereof to the implement frame 3 about a substantially horizontal arm pivot axis APA. The trailing arm 9 slopes rearward and downward to a packer wheel 11 rotatably mounted to a rear portion of the trailing arm 9R about a substantially horizontal packer rotational axis PRA.

An arm bias element 13 is attached to the implement frame 3 and to the trailing arm 9 and is operative to exert a downward and forward arm bias force ABF on the on the trailing arm about the arm pivot axis APA. The arm bias element 13 is illustrated as an arm hydraulic cylinder 13 extending outward to exert the arm bias force ABF such that the trailing arm 9 moves upward and slightly rearward and downward and slightly forward as the trailing arm 9 pivots about the arm pivot axis APA when travelling over undulating terrain.

A shank 15 is pivotally attached at an upper portion thereof to a middle portion of the trailing arm 9, between the arm pivot axis and the packer rotational axis PRA, about a substantially horizontal shank pivot axis SPA, and a furrow opener 17 is attached to a lower end of the shank 15,

A shank bias element 19 is connected between the trailing arm 9 and the shank 15 and is operative to exert a substantially forward and downward shank bias force SBF on the shank 15 to maintain the shank 15 in a shank operating position SOP. The illustrated shank bias element 19 is provided by a retracting hydraulic cylinder 19A wherein the retracting hydraulic cylinder 19A pulls the shank 15 toward the shank operating position SOP and is fully retracted when the shank 15 is in the shank operating position SOP.

In operation when the furrow opener 17 hits an obstruction the attached shank 15 pivots rearward and upward against the shank bias force SBF as shown in the dotted line. This pivotal movement is limited by a stop 21.

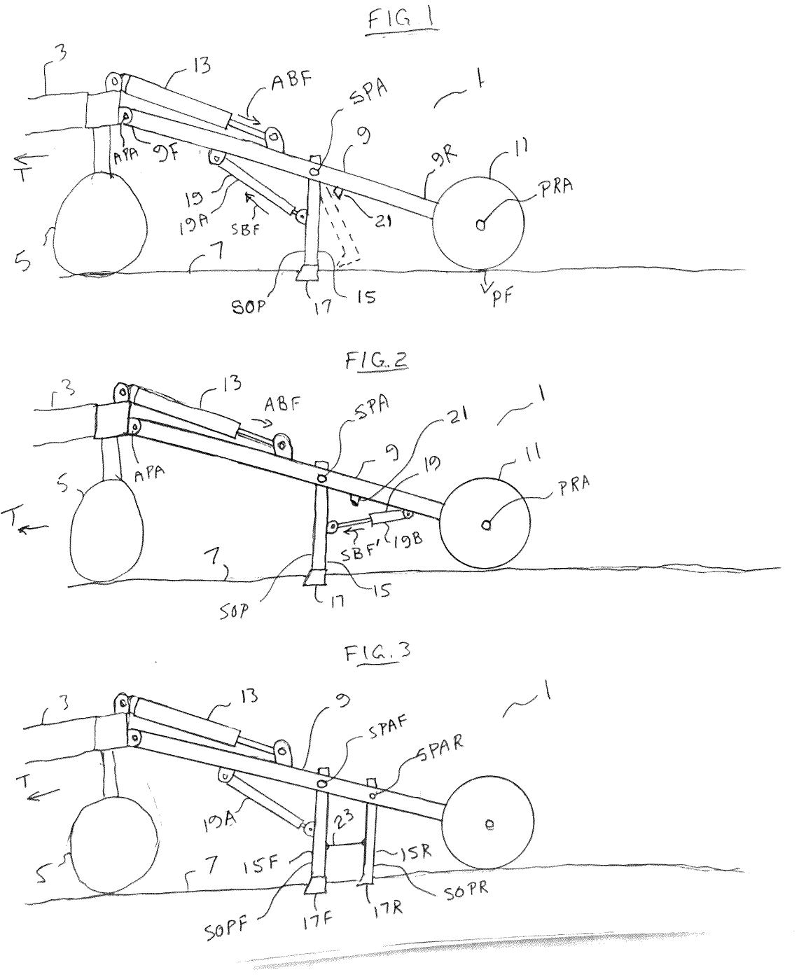

FIG. 2 schematically illustrates an alternate embodiment of the apparatus of the present invention wherein the shank bias element 19 pushes the shank 15 toward the shank operating position SOP. The shank bias element 19 here is provided by an extending hydraulic cylinder 19B and wherein the extending hydraulic cylinder 19B is fully extended when the shank 15 is in the shank operating position SOP.

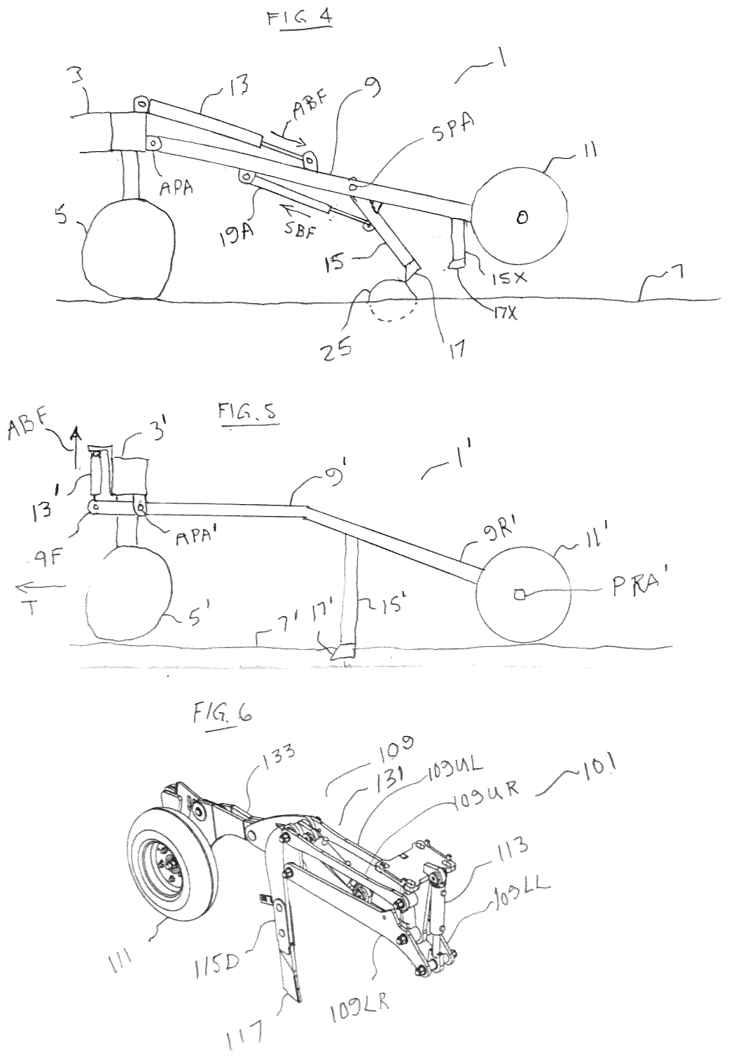

FIG. 3 schematically illustrates a further alternative embodiment of the apparatus of the present invention comprising front and rear shanks 15F, 15R pivotally attached at upper portions thereof to the middle portion of the trailing arm 19 about substantially horizontal front and rear shank pivot axes SPAF, SPAR. Corresponding front and rear furrow openers 17F, 17R are attached to the bottom of the front and rear shanks 15F, 15R.

In the illustrated embodiment the shank bias element 19 is provided by a retracting hydraulic cylinder 19A attached to the front shank 15F and a tether 23 joins the front and rear shanks 15F, 15R together such that when the retracting hydraulic cylinder 19A is fully retracted as shown, both of the front and rear shanks 15F, 15R are in a shank operating position SOPF, SOPR.

FIG. 4 schematically illustrates the furrow opener 17 of FIG. 1 striking a large obstruction, such as a rock 25. With such a large obstruction, the shank 15 is forced back against the Stop 21. When such a large obstruction is contacted by the furrow opener 17, the shank moves upward against the stop 21, the arm bias force ABF exerted by the arm bias element 13 is overcome by the force of the shank 15 against the stop 21, the arm bias element 13 move inward so that trailing arm 9 can move up in response to the force of the shank 15 and the packer wheel 11 moves up with the trailing arm 9. Once the obstruction is cleared, the trailing arm 9 moves down, the packer wheel 11 again contacts the ground and the shank 15 moves back to the shank operating position SOP. FIG. 4 also illustrates a seed shank 15X fixed to the trailing arm 9 quite close to the packer wheel 11. Such an arrangement allows the packer wheel 11 to follow close to the furrow opener 17X as is desirable in some conditions.

Thus the present invention provides a shank bias force SBF that is adjustable independent of the arm bias force ABF. This arrangement allows the packing force PF, which derives from the arm bias force ABF, to be adjusted independent of the shank bias force SBF to allow for varying soil conditions. For example when working in wetter heavy clay soils it may be necessary to increase the shank bias force SBF to ensure the furrow opener 17 penetrates to a desired depth, while at the same time reducing the arm bias force ABF to reduce the packing force PF to avoid over sealing of the furrow which can reduce crop emergence.

In sandy soils that are more easily penetrated by the furrow opener 17, it may be desirable reduce the shank bias force SBF and increase the arm bias force ABF to increase the downward force on the packer wheel 11.

FIG. 5 schematically illustrates a further apparatus 1′ comprising an implement frame 3′ mounted on wheels 5′ for travel over the ground 7′ in an operating travel direction T. A trailing arm 9′ is pivotally attached at a front portion 9F′ thereof to the implement frame 3′ about a substantially horizontal arm pivot axis APA′. The trailing arm 9′ slopes rearward and downward to a packer wheel 11′ rotatably mounted to a rear portion of the trailing arm 9R′ about a substantially horizontal packer rotational axis PRA′.

In this embodiment, the front portion 9F′ of the trailing arm 9′extends forward from the arm pivot axis APA′ to a front end thereof and the arm bias element 13′ is attached to the implement frame 3 and the front portion 9F′ of the trailing arm 9′. The arm bias element 13′ extends upward from the front end of the trailing arm 9″ and exerts the arm bias force ABF upward such that the trailing arm 9′ pivots downward about the arm pivot axis APA′ forcing the furrow opener 17′ into the ground 7′ and pushing the packer wheel 11′ against the ground.

This orientation of the arm bias element 13′ provides an arm bias element that has a substantially shorter stroke than the conventional arm bias elements shown in FIGS. 1-4, with correspondingly less variation in the position of the arm bias element as the trailing arm 9′ moves up and down, and more consistency in the forces on the packer wheel 11′ and furrow opener 17′. The apparatus 1′ is shown with a conventional fixed shank 15′, but could also be used with the biased shanks of FIGS. 1-4.

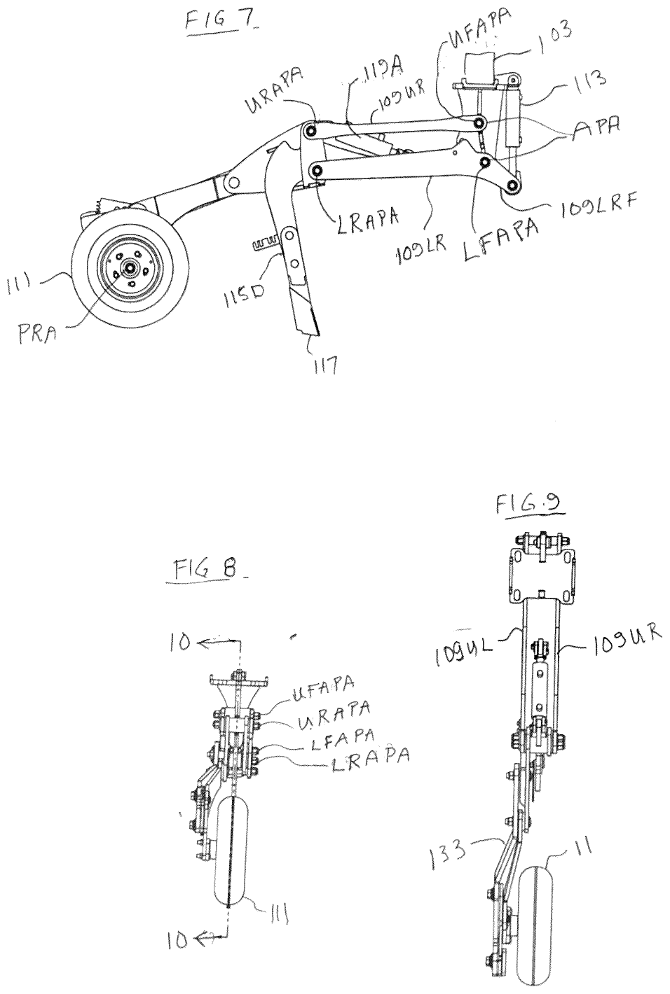

FIGS. 6-9 illustrate a further embodiment of the apparatus 101 of the present invention where the trailing arm 109 comprises a parallel arm assembly 131 as is known in the prior art attached to the implement frame 103. The horizontal arm pivot axis APA is provided by upper and lower front arm pivot axes UFAPA LFAPA mounted on the implement frame 103 and upper and lower rear arm pivot axes URAPA, LRAPA mounted on a middle section of the trailing arm 109, which includes upper right and left pivot arms 109UR, 109UL and lower right and left pivot arms 109LR, 109LL.

A packer arm 133 extends rearward from the upper and lower rear arm pivot axes URAPA, LRAPA and the packer wheel 111 is mounted to the packer arm 133 about the packer rotational axis PRA.

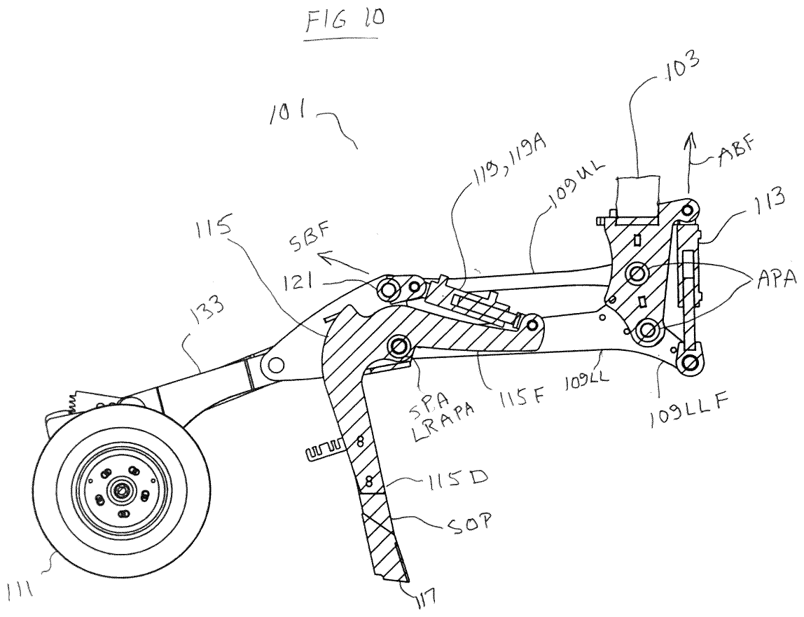

As best seen in the sectional view of FIG. 10, in the illustrated embodiment the shank pivot axis SPA conveniently coincides with the lower rear arm pivot axis LRAPA. The shank 115 comprises a downward shank portion 115D extending downward from the lower rear arm pivot axis LRAPA, also the shank pivot axis SPA, and a forward shank portion extending forward from the lower rear arm pivot axis LRAPA, also the shank pivot axis SPA. The furrow opener 117 is attached at a bottom end of the downward shank portion 115D.

The shank bias element 119 is illustrated as a retracting hydraulic cylinder 119A and exerts the shank bias force SBF on the forward shank portion 115F to force the front shank portion upward and pivot the shank about the SPA to force the downward shank portion 115D into the shank operating position SOP shown in FIG. 10. The shank 115 pivots about the shank pivot axis SPA in range from the operating position SOP to the stop 121.

The forward portions 109LRF and 109LLF of the lower right and left pivot arms 109LR, 109LL extend forward from the arm pivot axis APA to front ends thereof and the arm bias element is connected to the front ends. The arm bias element 113 extends upward from the front ends of the lower right and left pivot arms 109LRF, 109LLF and exerts the arm bias force ABF upward, substantially vertically in the illustrated embodiment 101.

As in prior art implements, as the furrow opener moves through the ground to prepare a furrow, the soil moving against the furrow opener exerts a rearward force on the furrow opener and thus an upward force on the trailing arm about the arm pivot axis. However in the present disclosure the shank is pivotally attached to the trailing arm and a bias element acts to pivot the shank to the operating position and allows the shank to move rearward and upward when an obstruction is encountered with less effect on the down pressure the trailing arm exerts on the packer wheel. The shank can pivot within a range between the shank operating position and a stop, at which point the shank pivots against the stop and causes the trailing arm to move upward against the arm bias force.

The present disclosure also provides a novel location for the arm bias element that is forward of the arm pivot axis such that an upward force on the front end of the trailing arm forces the packer wheel and shank downward.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A seeding apparatus comprising:
an implement frame mounted on wheels for travel over the ground in an operating travel direction;
a trailing arm pivotally attached at a front portion thereof to the implement frame about a substantially horizontal arm pivot axis and extending rearward and downward to a packer wheel rotatably mounted to a rear portion of the trailing arm about a substantially horizontal packer rotational axis;
an arm bias element attached to the implement frame and to the trailing arm and operative to exert a downward and forward arm bias force on the trailing arm about the arm pivot axis;
a shank pivotally attached at an upper portion thereof to a middle portion of the trailing arm about a substantially horizontal shank pivot axis, and a furrow opener attached to a lower end of the shank;
a shank bias element connected between the trailing arm and the shank and operative to exert a forward and downward shank bias force on the shank to maintain the shank in a shank operating position.

2. The apparatus of claim 1 wherein the shank is operative to pivot between the shank operating position and a shank stop position.

3. The apparatus of claim 2 wherein the trailing arm comprises:
a parallel arm assembly and wherein the horizontal arm pivot axis is provided by upper and lower front arm pivot axes mounted on the implement frame and upper and lower rear arm pivot axes mounted on a middle portion of the trailing arm;
a packer arm extending rearward from the upper and lower rear arm pivot axes wherein the packer wheel is rotatably mounted to the packer arm.

4. The apparatus of claim 3 wherein the shank comprises a downward shank portion extending downward from the lower rear arm pivot axis and a forward shank portion extending forward from the lower rear arm pivot axis.

5. The apparatus of claim 4 wherein the shank bias element exerts the shank bias force on the forward shank portion.

6. The apparatus of claim 5 wherein the shank pivot axis coincides with the lower rear arm pivot axis.

7. The apparatus of claim 1 comprising front and rear shanks pivotally attached at upper portions thereof to the middle portion of the trailing arm about substantially horizontal front and rear shank pivot axes, and comprising a tether joining the front and rear shanks.

8. The apparatus of any one of claim 1 wherein the shank bias element pulls the shank toward the shank operating position.

9. The apparatus of claim 8 wherein the shank bias element is provided by a retracting hydraulic cylinder and wherein the retracting hydraulic cylinder is fully retracted when the shank is in the shank operating position.

10. The apparatus of claim 1 wherein the shank bias element pushes the shank toward the shank operating position.

11. The apparatus of claim 10 wherein the shank bias element is provided by an extending hydraulic cylinder and wherein the extending hydraulic cylinder is fully extended when the shank is in the shank operating position.

12. The apparatus of claim 1 wherein the arm pivot axis is mounted to the implement frame and the front portion of the trailing arm extends forward from the arm pivot axis to a front end thereof, and wherein the arm bias element extends upward from the front end of the trailing arm and exerts the arm bias force upward.

13. The apparatus of claim 12 where in the arm bias element is attached to the implement frame and the front end of the trailing arm and exerts the bias force upward.

14. A seeding apparatus comprising:
an implement frame mounted on wheels for travel over the ground in an operating travel direction;
a trailing arm pivotally attached at a front portion thereof to the implement frame about a substantially horizontal arm pivot axis and extending rearward and downward to a packer wheel rotatably mounted to a rear portion of the trailing arm about a substantially horizontal packer rotational axis;
a shank extending downward from a middle portion of the trailing arm, and a furrow opener mounted on a lower end of the shank;
wherein a front end of the trailing arm extends forward of the arm pivot axis;
an arm bias element attached to the implement frame and to the front end of the trailing arm and operative to exert an arm bias force on the front end of the trailing arm to exert a downward and forward arm bias force on the on the trailing arm.

15. The apparatus of claim 14 wherein the arm bias element exerts the arm bias force in an upward direction.

16. The apparatus of claim 15 wherein the shank is pivotally attached at an upper portion thereof to the middle portion of the trailing arm about a substantially horizontal shank pivot axis, and a shank bias element is connected between the trailing arm and the shank and is operative to exert a substantially forward and downward shank bias force on the shank to maintain the shank in a shank operating position.
